(19) United States
(12) Patent Application Publication
(10) Pub. No.: US 2025/0060501 A1
(43) Pub. Date: Feb. 20, 2025

(54) Method and Apparatus for Automated Real-time Earthing Grid and Earthing Electrode Health Monitoring

(71) Applicant: Chintan Patel, San Jose, CA (US)

(72) Inventor: Chintan Patel, San Jose, CA (US)

(21) Appl. No.: 18/798,713

(22) Filed: Aug. 8, 2024

(51) Int. Cl. G01V 3/02; G01V 3/38

(52) U.S. Cl. CPC G01V 3/02; G01V 3/38

(57) ABSTRACT

Method and apparatuses for automated real-time health monitoring of earthing grid and earthing electrode are provided. One or more monitoring device designed for hazardous outdoor locations can be installed permanently on earthing grid to monitor its health. Each monitoring device can monitor earthing grid health by performing specific measurements on pre-scheduled basis or on-demand basis. Each monitoring device performs automated sequence of steps to measure earthing electrode resistance, effective earthing grid resistance, electrical mains frequency leakage currents, electrical noise; and communicate the measurements in real-time to external remote systems.

### PRIOR ART

According to the prior art, manual or semi-manual test procedures (using stake-less or one or more stakes) are employed for testing earthing grids where considerable time and manual labor is involved for setting up test equipment and running test procedures. Testing done as per the prior art is less accurate due to variation in performing the same manual activities, and variation in setting up the test equipment. Besides, such procedures do not provide timely measurements.

### BACKGROUND OF THE INVENTION

Earthing grids are a mandatory safety mechanism in all commercial, industrial and residential facilities and buildings. Improper earthing can result in numerous issues such as electrical energy measurement errors, equipment damage, hazardous events (fire, shock) causing damage to life and property. Earthing grids are designed, constructed and maintained to meet local safety standards. Earthing grids consist of multiple Earth Pits located across the facility (or site) connected with strips of conductive metal or cables to form a conductive (for electric charges) grid. Each Earthing Pit consists of a pit containing conductive materials (special chemicals or salts) and an electrode. The electrode connects to the Earthing grid using conductive metal strip or cable. All equipment, buildings, power systems are connected to the Earthing Grid to allow any accidental current leakages or lightning surges to flow effectively into the ground. A well designed and operational Earthing Grid conducts all unintentional leakage currently effectively into ground and prevents any hazards. A properly functioning Earthing Grid is of vital importance to meet local regulations and avert costly disasters. Earthing Grid's functioning degrades over time owing to multiple factors such as corrosion, rust, damage etc. To ensure Earthing grid functions properly, it is important to carry out regular maintenance of Earthing grid which involves testing the grid health and taking corrective actions in case of adverse findings.

The health of Earthing Grid is represented by effective resistance of all the Earthing Pits connected to the Grid. The connection of each Earth Pit to the Earth Grid (on one side) and to ground (on other side) creates a path for leakage currents to flow. Each electrode introduces electrical resistance (termed as “Electrode Resistance” or “Earth-Pit Resistance” measured in Ohms) to the electric leakage currents flowing through it to ground. The effective resistance of all the parallelly connected Earthing Electrodes form the “Grid Resistance” measured in Ohms. The health of Earthing Grid can be determined by measuring the Electrode Resistance and Grid Resistance. The goal of a well-designed healthy Earthing Grid is to have close to zero resistance (in Ohms) for each of Earth-Pit's Electrode Resistance and Grid Resistance. In reality this is rarely achieved as there is always some resistance to the leakage current flowing through Grid and Earth Pit.

Whenever there is earthing leakage (of signal at principle electrical frequency or other noise), a proper functioning earthing grid will conduct it safely to earth. However, the existing monitoring mechanisms as per prior art cannot identify automatically if there is active leakage and where in the grid is a leakage occurring. Eliminating leakage faults is the safest approach, and hence it is very important to identify if there is leakage and locate the source of leakage for corrective actions.

When designing earthing grids, it is important to measure soil resistance and space the earthing-pits to achieve an approximate equivalent resistance for leakages flowing to earth. Measuring soil resistance is also a best practice for ongoing earthing grid monitoring as it reflects the inherent resistance to the ground leakages.

The monitoring of earthing grid is carried out by testing regularly for Electrode Resistance and effective Grid Resistance. This is done according to prior art using manual or semi-automatic test procedures which do not produce consistently accurate and timely results. This approach is both costly, time-consuming and introduces risks associated with inaccurate results. This invention introduces a new approach to automatically monitor the earthing grid in real-time.

### SUMMARY OF THE INVENTION

The present invention addresses the aforementioned concerns, and others, of prior art.

The present invention provides a fully-contained monitoring unit that once installed can be used to automatically monitor the health of an earthing grid in real-time by measuring individual earthing electrode resistance, effective grid resistance, electrical mains frequency leakage currents, and electrical noise. This monitoring can be accomplished without any manual activity or grid disconnections. The monitoring unit has communication capability allowing it to receive commands from remote systems, and respond with the earthing grid measurement data. The earthing grid data can then be trended, monitored and used for alerting and analytics in real-time.

In a preferred embodiment of the present invention, the monitoring unit comprises of a main processing sub-unit handling power management, data processing and communications; and an auxiliary sensor sub-unit handling the sensing. In this embodiment, the monitoring unit will be powered by battery, and use wireless communications (Zigbee or Bluetooth) to receive commands and send responses and data. In this embodiment, the monitoring unit will be designed and manufactured to comply to IP67 rating for deployment in outdoor under-ground locations.

In an alternative embodiment, the monitoring unit will be designed and manufactured to meet hazardous area installation requirements in compliance with IEC 60079-11.

In an alternative embodiment, the monitoring unit will be powered by wired 12-24 VDC supply, and it will use wireless communications to receive commands and send responses and data.

In an alternative embodiment, the monitoring unit will be powered by wired 12-24 VDC supply, and it will use wired RS-485 communications to receive commands and send responses and data.

In an alternative embodiment, the monitoring unit will be powered by battery, and it will use wireless communications to receive commands and send responses and data.

In an alternative embodiment, the monitoring unit will be powered by solar panel+charger+battery, and it will use wireless communications to receive commands and send responses and data.

In an alternative embodiment, the monitoring unit will be powered by solar panel+charger+battery, and it will use wired RS-485 communications to receive commands and send responses and data.

### BRIEF DESCRIPTION OF DRAWINGS

The current invention will hereinafter be described in conjunction with the appended drawings, provided to illustrate and not to limit the disclosed aspects.

FIG. 1 shows monitoring unit comprising of main processing sub-unit, auxiliary sensor coil sub-unit and auxiliary sensor stake sub-unit in preferred embodiment according to current invention for monitoring earthing grid.

FIG. 2 shows representative earthing grid Eg1 comprising of 3 Earthing electrodes

FIG. 3a shows the monitoring unit setup installed on earthing grid Eg1 to monitor Ee1 and Eg1.

FIG. 3b shows the monitoring unit's logical component schematic as installed on Eg1 to monitor Ee1 and Eg1

FIG. 4 shows the method proposed in current invention for monitoring Earthing grid health using automated, real-time measurements of earthing electrode resistance, earthing grid resistance, electrical mains frequency leakage currents, and electrical noise

### DETAILED DESCRIPTION OF THE INVENTION

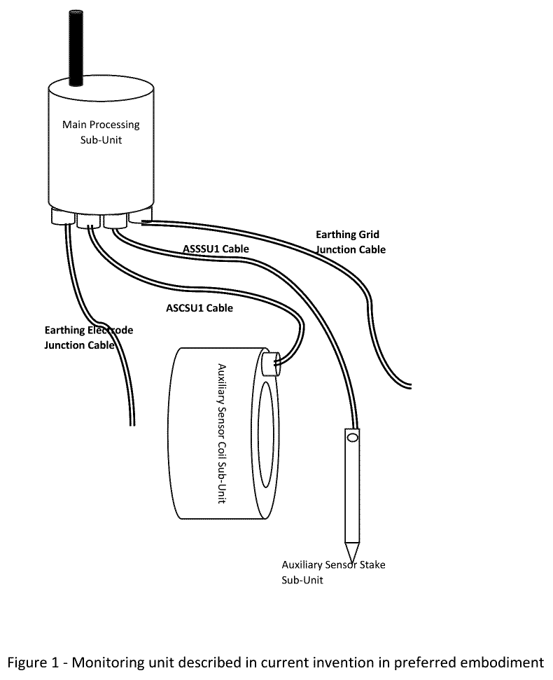

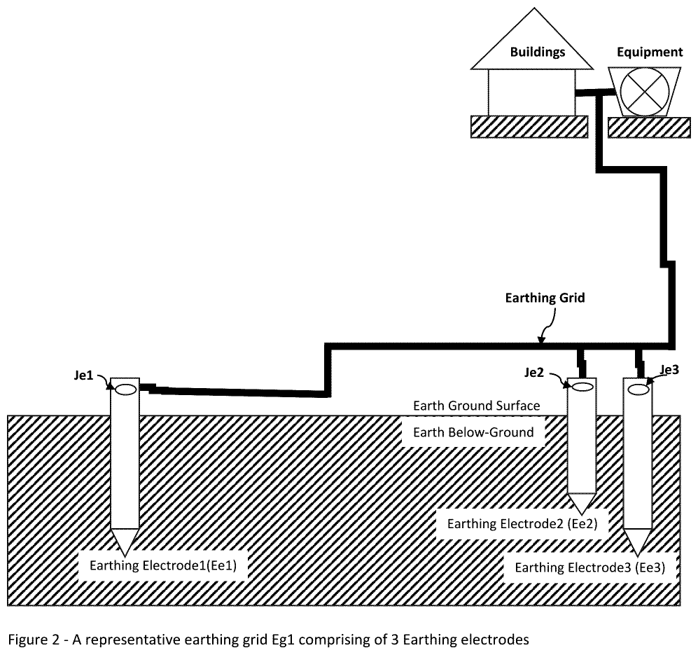

As per current invention, the apparatus comprising of one or more monitoring units needs to be installed permanently on earthing grid to be monitored. Each monitoring unit comprises of main processing sub-unit (MPSU), auxiliary sensor coil sub-unit (ASCSU) and auxiliary sensor stake sub-unit (ASSSU) as shown in FIG. 1. The current invention is applicable to monitoring of one or more electrodes in earthing grid. A typical earthing grid comprises of one or more earthing electrodes that are installed permanently in ground and inter-connected with a conductive strip or cable often with junctions to allow branching. The equipment, buildings, facilities that need earthing protection are then connected to the earthing grid using conductive strip or cable. FIG. 2 shows a representative earthing grid Eg1 comprising of 3 Earthing electrodes (Ee1, Ee2, Ee3) interconnected using earthing conductor and junctions (Je1, Je2, Je3) to provide earthing protection to a building and equipment. In practice, the earthing grids are designed to meet the earthing protection needs of assets it protects in accordance with local regulations. The electrodes are installed below ground surface using special materials to allow conductivity of leakages to ground.

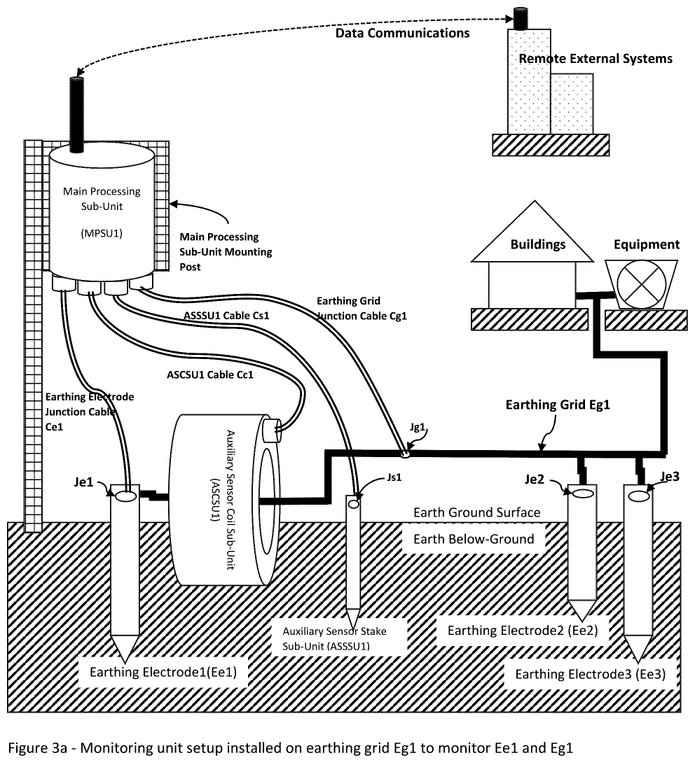

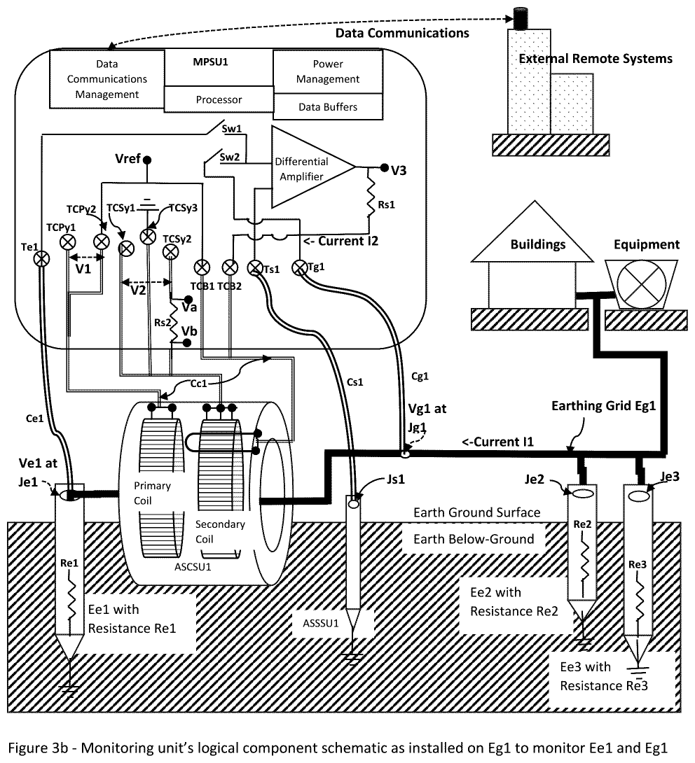

FIG. 3a shows earthing grid monitoring setup for monitoring Earthing Electrode 1 (Ee1) resistance, Earthing Grid 1 (Eg1) resistance, Electrical Mains Frequency leakage, and Electrical Noise. When monitoring electrode Ee1, the grid resistance comprises of effective resistance of rest of all earthing electrodes—i.e. Earthing Electrode 2 (Ee2) and Earthing Electrode 3 (Ee3). In this context, the effective grid resistance will be equal to effective parallel resistance of Re2 and Re3. The monitoring unit is installed permanently on Ee1 that is part of Earthing Grid Eg1 to be monitored as shown in FIG. 3a. In a small earthing grid (spread on small area), it may be sufficient to monitor one Earthing Electrode as shown in FIG. 3a. However, for large earthing grids (spread on large area), it is required to monitor multiple earthing electrodes as the soil structure may not be uniform and will present variation in electrode resistances. If there is a need to monitor additional earthing electrodes, similar installation is done on those electrodes. The main processing sub-unit of monitoring unit is referred to as MPSU1, auxiliary sensor coil sub-unit is referred to as ASCSU1 and auxiliary sensor stake sub-unit is referred to as ASSSU1. The main processing sub-unit MPSU1 is mounted permanently on rigid mounting post near the earthing electrode Ee1 to be monitored, and is connected to the junction Je1 of earthing grid and earthing electrode using cable Ce1. In preferred embodiment, the main processing sub-unit MPSU1 is powered by battery, and configured to communicate with external remote systems over wireless links. The auxiliary sensor coil sub-unit ASCSU1 is clamped around the earthing conductor connecting the earthing electrode Ee1 and earthing grid Eg1. The auxiliary sensor coil sub-unit ASCSU1 is inductively coupled to the earthing grid Eg1 and not physically connected to the earthing grid. The auxiliary sensor coil sub-unit ASCSU1 is usually installed below earth ground surface, and connected to main processing sub-unit MPSU1 using cables Cc1. The auxiliary sensor stake sub-unit ASSSU1 is installed at distance of more than 5 feet away from earthing electrode Ee1, and its tip is installed 1 feet below earth ground surface. The auxiliary sensor stake sub-unit ASSSU1 is connected via junction Js1 to main processing sub-unit MPSU1 using cable Cs1. The main processing sub-unit MPSU1 is also connected to earthing grid junction Jg1 using cable Cg1.

The monitoring unit's logical component schematic is shown in FIG. 3b to illustrate the important components of the apparatus of current invention that execute the method proposed in current invention. MPSU1 comprises of these components: Power Management, Data Communications Management, Processor, Data Buffers, Differential Amplifier, Test Signal generation/injection, Signal detection/analysis, cables/terminals. The ASCSU1 comprises of these components: Primary Coil, Secondary Coil, Secondary Bias Signal, cables/terminals. MPSU1 is connected to ASCSU1, ASSSU1, Eg1Ee1 (monitored electrode) using cables via Terminals on MPSU1. All cables are single conductor cables except cable Cc1 for ASCSU1 which is multi-conductor cable (i.e multi-core). MPSU1 is connected to Ee1 junction Je1 using cable Ce1 via Terminal Te1. MPSU1 is connected to ASCSU1 using cable Cc1 via Terminals TcPy1, TcPy2, TCSy1, TCSy2, TCSy3, TCB1, TCB2. MPSU1 is connected to ASSSU1 using cable Cs1 via Terminal Ts1. MPSU1 is connected to Eg1 using cable Cg1 via Terminal Tg1. The logical functioning of the components is explained in the method description below.

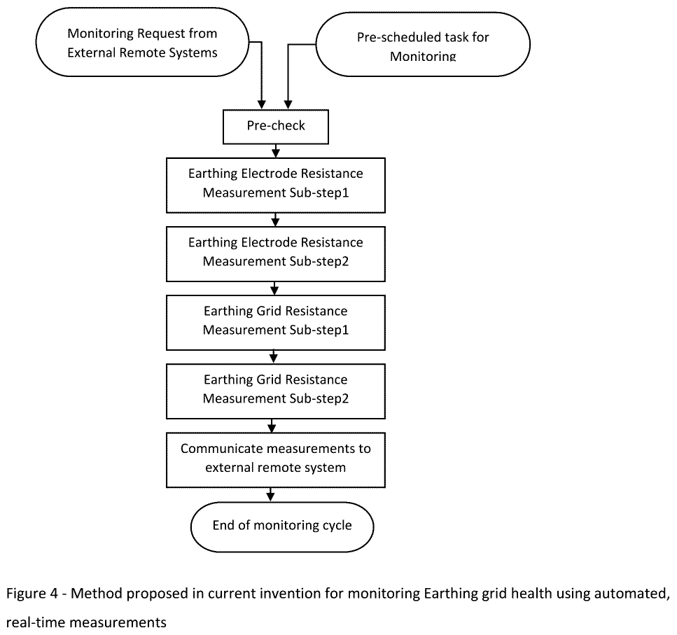

After the one-time installation of monitoring unit, the health of earthing grid can be monitored automatically and in real-time by giving periodic measurement requests from external remote systems or scheduling measurements at pre-defined intervals. Irrespective of the mode of measurement requests, the measurements are done following an automatic sequence of steps shown in FIG. 4 and described below. The measurements are communicated back to the external remote systems using the configured communication mechanism.

Pre-check: MPSU1 sets Test Signal Frequency Fi to value between (4.44 KHz to 8.88 KHz) distinct from Electrical Mains Frequency. MPSU1 captures signal from ASCSU1 secondary coil without providing any excitation to ASCSU1 primary coil. MPSU1 performs FFT on signal and calculates Electrical Mains Frequency Leakage (50 or 60 Hz) and Electrical Noise (all other frequencies). If Electrical Noise signal contains Test Signal Injection Frequency components, then the Test Signal Injection Frequency Fi is changed and the Pre-check step is repeated till a test signal frequency is identified that is not present in the Electrical noise signal. The final Electrical Mains Frequency Leakage and Electrical Noise measurements are saved in MPSU1 data buffer.

Earthing Electrode Resistance Measurement Sub-step1: MPSU1 keeps Sw1 open and Sw2 Open at input of Differential Amplifier. MPSU1 excites ASCSU1 Primary coil with Test Signal of fixed voltage V1 and fixed frequency Fi (identified in previous step). This results in induction of Voltage V1′ across loop of Electrode resistance, Grid Resistance, and Soil Resistance (equivalent to series connected resistances). This develops current I1 in the earthing loop whose value depends on Electrode Resistance Re1 and Grid Resistance Rg1. Same current I1 flowing through ASCSU1 secondary coil will induce voltage V2. This signal at ASCSU1 secondary coil terminals is acquired by MPSU1, FFT transformation is performed and the FFT amplitude at Test Signal Injection Frequency Fi is extracted. This amplitude is saved in data buffers as Mag1. Mag1 is proportional to I1.

Earthing Electrode Resistance Measurement Sub-step2: MPSU1 closes Sw1, keeping Sw2 open at input of Differential Amplifier. MPSU1 excites ASCSU1 Primary coil with Test Signal of fixed voltage V1 and fixed frequency Fi (identified in previous step). Sw1 closing applies the voltage Ve1 developed at Junction Je1 to MPSU1 Differential Amplifier input. The other input to MPSU1 Differential Amplifier is Vs1 developed at ASSSU1 Junction Js1. This differential input induces additional bias current I2 flowing through the output of MPSU1 Differential Amplifier, through the ASCSU1 secondary coil to the ground. The output signal of MPSU1 Differential Amplifier and output signal of ASCSU1 secondary coil is analyzed and FFT component at Test Signal Injection Frequency Fi is extracted. The FFT amplitude at Test Frequency at the Differential Amplifier output is voltage V3 and at ASCSU1 secondary coil is voltage V2′. V2′ is saved in data buffers as Mag2. Mag2 is proportional to (I1+I2). The earthing electrode resistance Re1 is calculated using formula: ((Mag2−Mag1)/Mag1)*Rs1 and saved in data buffers. The formula is arrived at by following the steps below. Refer to FIG. 5 for a simplified model of earthing grid showing the equivalent resistances, voltage and current.

$$I 1 = V {1}^{′} / ( Re 1 + Rg 1 ) \\ Ve 1 = I 1 * Re 1 = ( V {1}^{′} / ( Re 1 + Rg 1 ) ) * Re 1 \\ I 2 = V 3 / Rs 1 , V 3 = Ve 1 \\ I 2 = ( ( V {1}^{′} / ( Re 1 + Rg 1 ) ) * Re 1 ) / Rs 1 \\ ( Mag 2 - Mag 1 ) / Mag 1 = ( ( I 2 + I 1 ) - I 1 ) / I 1 = I 2 / I 1 = ( ( ( V {1}^{′} / ( Re 1 + Rg 1 ) ) * Re 1 ) / Rs 1 ) / ( V {1}^{′} / ( Re 1 + Rg 1 ) ) = Re 1 / Rs 1 \\ Hence Re 1 = ( ( Mag 2 - Mag 1 ) / Mag 1 ) * Rs 1$$

Earthing Grid Resistance Measurement Sub-step1: This step is same as Earthing Electrode Resistance Measurement Sub-step1. MPSU1 keeps Sw1 open and Sw2 Open at input of Differential Amplifier. MPSU1 excites ASCSU1 Primary coil with Test Signal of fixed voltage V1 and fixed frequency Fi (identified in previous step). This results in induction of Voltage V1′ across loop of Electrode resistance, Grid Resistance, and Soil Resistance (equivalent to series connected resistances). This develops current I1 in the loop whose value depends on Electrode Resistance Re1 and Grid Resistance Rg1. Same current I1 flowing through ASCSU1 secondary coil will induce voltage V2. This signal at ASCSU1 secondary coil terminals is acquired by MPSU1, FFT transformation is performed and the FFT amplitude at Test Signal Injection Frequency Fi is extracted. This amplitude is saved in data buffers as Mag1. Mag1 is proportional to I1.

Earthing Grid Resistance Measurement Sub-step2: MPSU1 closes Sw2, keeping Sw1 open at input of Differential Amplifier. MPSU1 excites ASCSU1 Primary coil with Test Signal of fixed voltage V1 and fixed frequency Fi (identified in previous step). Sw2 closing applies the voltage Vg1 developed at Junction Jg1 to MPSU1 Differential Amplifier input. The other input to MPSU1 Differential Amplifier is Vs1 developed at ASSSU1 Junction Js1. This differential input induces additional bias current I2 flowing through the output of MPSU1 Differential Amplifier, through the ASCSU1 secondary coil to the ground. The output signal of MPSU1 Differential Amplifier and output signal of ASCSU1 secondary coil is analyzed and FFT component at Test Signal Injection Frequency Fi is extracted. The FFT amplitude at Test Frequency at the Differential Amplifier output is voltage V3 and at ASCSU1 secondary coil is voltage V2′. V2′ is saved in data buffers as Mag2. Mag2 is proportional to (I1+I2). The earthing grid resistance Rg1 is calculated using formula: ((Mag2−Mag1)/Mag1)*Rs1 and saved in data buffers. The formula is arrived at by following the steps below. Refer to FIG. 5 for a simplified model of earthing grid showing the equivalent resistances, voltage and current.

$$I 1 = V {1}^{′} / ( Re 1 + Rg 1 ) \\ Vg 1 = I 1 * Rg 1 = ( V {1}^{′} / ( Re 1 + Rg 1 ) ) * Rg 1 \\ I 2 = V 3 / Rs 1 , V 3 = Vg 1 \\ I 2 = ( ( V {1}^{′} / ( Re 1 + Rg 1 ) ) * Rg 1 ) / Rs 1 \\ ( Mag 2 - Mag 1 ) / Mag 1 = ( ( I 2 + I 1 ) - I 1 ) / I 1 = I 2 / I 1 = ( ( ( V {1}^{′} / ( Re 1 + Rg 1 ) ) * Rg 1 ) / Rs 1 ) / ( V {1}^{′} / ( Re 1 + Rg 1 ) ) = Rg 1 / Rs 1 \\ Hence Rg 1 = ( ( Mag 2 - Mag 1 ) / Mag 1 ) * Rs 1$$

Communication of measurement data to external remote systems: MPSU1 conveys the electrode resistance, earthing grid resistance, electrical mains frequency leakage currents, electrical noise measurements saved in data buffers to external remote systems using the communication link configured during setup.

1. An apparatus for real-time monitoring of earthing grid health comprising of a monitoring device including:
main processing sub-unit, auxiliary sensor coil sub-unit and auxiliary sensor stake sub-unit;
wherein said main processing sub-unit is adapted to be powered by battery;
wherein said main processing sub-unit is adapted to perform wireless data communications with external remote systems;
wherein said main processing sub-unit is adapted to be permanently connected to one earthing electrode, the auxiliary sensor coil sub-unit, the auxiliary sensor stake sub-unit and earthing grid;
wherein said auxiliary sensor coil sub-unit is adapted to be clamped permanently onto the earthing conductor connecting the earthing electrode and earthing grid;
wherein said auxiliary sensor coil sub-unit is adapted to achieve IP67 rating to allow outdoor under-ground installations;
wherein said auxiliary stake sub-unit is located 5 feet away from the earthing electrode to be monitored and inserted 1 feet deep into earth-surface;
wherein said main processing sub-unit is adapted to measure the earthing grid health parameters on pre-determined schedule or on request from external remote systems;
wherein said main processing sub-unit is adapted to measure the earthing grid health parameters by executing a sequence of automated steps storing the intermediate and final data;
wherein said main processing sub-unit is adapted to communicate the measured earthing grid health parameters to external remote systems.

2. The apparatus of claim 1 wherein power is supplied over wired connection instead of battery.

3. The apparatus of claim 1 wherein power is supplied using solar panel instead of battery.

4. The apparatus of claim 1 wherein data communication happens using wireless protocol such as Zigbee or Bluetooth protocol.

5. The apparatus of claim 1 wherein data communication happens using RS-485 protocol over wired connection instead of wireless data communication.

6. The apparatus of claim 1 wherein the main processing sub-unit, auxiliary sensor sub-units are adapted to meet hazardous area installations in compliance with IEC 60079-11.

7. A method for automated real-time monitoring method of earthing grid heath comprising steps of:
installation of monitoring device and connection to earthing electrode and earthing grid;
powering the monitoring device by at least one power source;
establishing data communication between monitoring device and external remote systems; executing sequential automated steps of:
identifying appropriate Test Signal Injection Frequency;
generating known low voltage (2-3 V), high frequency (4.44 KHz to 8.88 kHz) test signal;
injecting test signal into auxiliary sensor coil sub-unit's primary coil;
measuring resulting signal from auxiliary sensor coil sub-unit's secondary coil;
modifying the injected test signal into auxiliary sensor coil sub-unit's secondary coil by operating electronic switches;
measuring resulting signal from auxiliary sensor coil sub-unit's secondary coil;
calculating and storing electrode resistance, grid resistance, electrical mains frequency leakage currents and electrical noise;
and communicating the measured earthing grid health parameters to external remote systems.

8. The method of claim 7 wherein the said power source is selected from group of battery power, wired power or solar panel power.

9. The method of claim 7 wherein the said data communication is selected from group of wired RS-485 communication or wireless Zigbee or wireless Bluetooth.

10. The method of claim 7 wherein the said monitoring method doesn't require disconnection of any part of earthing grid after initial installation.

11. The method of claim 7 wherein the said monitoring method can be executed on request from external remote systems or on pre-scheduled basis.
